(19) United States
(12) Patent Application Publication
(10) Pub. No.: US 2010/0041265 A1
(43) Pub. Date: Feb. 18, 2010

(54) USB LOCKING STRUCTURE

(76) Inventor: Chih-Chiang WANG, Taipei County (TW)

Correspondence Address: RABIN & Berdo, PC, 1101 14TH STREET, NW, SUITE 500, WASHINGTON, DC, 20005, US

(21) Appl. No.: 12/191,448

(22) Filed: Aug. 14, 2008

(51) Int. Cl. H01R 13/627

(52) U.S. Cl. 439/353

(57) ABSTRACT

A USB locking structure mainly includes a USB socket and a collar. The USB socket is disposed with a plurality of locking pieces. The collar has a rectangular through hole in the middle for being movably fitted on the USB socket. In use, after a USB plug is inserted into the USB socket, the locking pieces are engaged in locking slots of the USB plug. The collar reciprocally slides outside the USB socket so as to press against the locking pieces to catch the USB plug or be separated from the locking pieces to release the USB plug. Thereby, the present invention is quite convenient in operation.

### BACKGROUND OF THE INVENTION

1. Field of Invention

The present invention relates to a structure for locking a USB plug, and more particularly to a USB locking structure using a collar to press against locking pieces of a USB socket, so as to catch a USB plug.

2. Related Art

A universal serial bus (USB) commonly used in computers and various expanded equipments for data transmission usually includes a USB socket and a USB plug, and is capable of rapidly accomplishing information linking by inserting the USB plug into the USB socket, so as to perform the data transmission. Currently, the USB is more widely applied in various small household appliances for being electrically connected to the computer, so as to be charged or directly gain power for use.

Referring to FIG. 1, a USB socket 10 has a plurality of locking pieces 101 respectively formed on an upper and a lower face thereof, and a USB plug 20 has locking slots 201 disposed at corresponding positions. The locking pieces 101 may be assembled with the locking slots 201 correspondingly formed on the USB plug 20. After the USB socket 10 is assembled with the USB plug 20, the locking pieces 101 and the locking slots 201 are engaged to accomplish the information linking or electrical connection. However, as the locking pieces 101 are elastic, the USB plug 20 can be rapidly detached, and thus the locking pieces 101 are unable to catch the USB plug 20 when the USB plug 20 is pulled by an external force. Thereby, the USB plug 20 may easily fall off, not only resulting in inconvenience in use but also damages to the data or equipment. As such, the USB socket and the USB plug need to be improved.

### SUMMARY OF THE INVENTION

In order to solve the above problem, the inventor of the present invention puts forward a brand-new USB locking structure based on careful researches and many years' experience in this field.

The present invention is mainly directed to a USB locking structure convenient in operation and capable of rapidly changing the locking state of a USB plug inserted in a USB socket.

In order to achieve the above objective, a USB locking structure mainly including a collar and a USB socket is provided. The USB socket is disposed with a plurality of locking pieces on each side wall. The collar is disposed with a rectangular through hole in the middle. The through hole is of the same shape as the USB socket and slightly larger in size. The collar is fitted on the USB socket and capable of moving by sliding. In addition, the through hole of the collar is disposed with a recess on an inner side wall at a position corresponding to each of the locking pieces, respectively.

After the USB plug is inserted into the USB socket, the locking pieces of the USB socket are respectively engaged in the locking slots of the USB plug to form a semi-locking state (a state in which the USB plug can be released by merely applying a force). Therefore, in the usage of the present invention, the collar slides toward the end of the USB socket disposed with the locking pieces, and each of the locking pieces penetrates the recess of the collar to form a pressing respectively, such that the locking pieces are unable to be detached from inside the locking slots of the USB plug. Thus, the USB plug is caught and may not easily drop off under the pulling of an external force. On the contrary, after the collar slides toward the other end, the locking pieces may be released from the pressing of the collar and recover a movable state, such that the USB plug is easy to be detached. Therefore, the present invention can easily change the state of the USB plug by merely reciprocally sliding the collar, and is quite convenient in operation.

### BRIEF DESCRIPTION OF THE DRAWINGS

The present invention will become more fully understood from the detailed description given herein below for illustration only, and thus are not limitative of the present invention, and wherein:

FIG. 1 is a schematic view illustrating the usage of a convention USB socket;

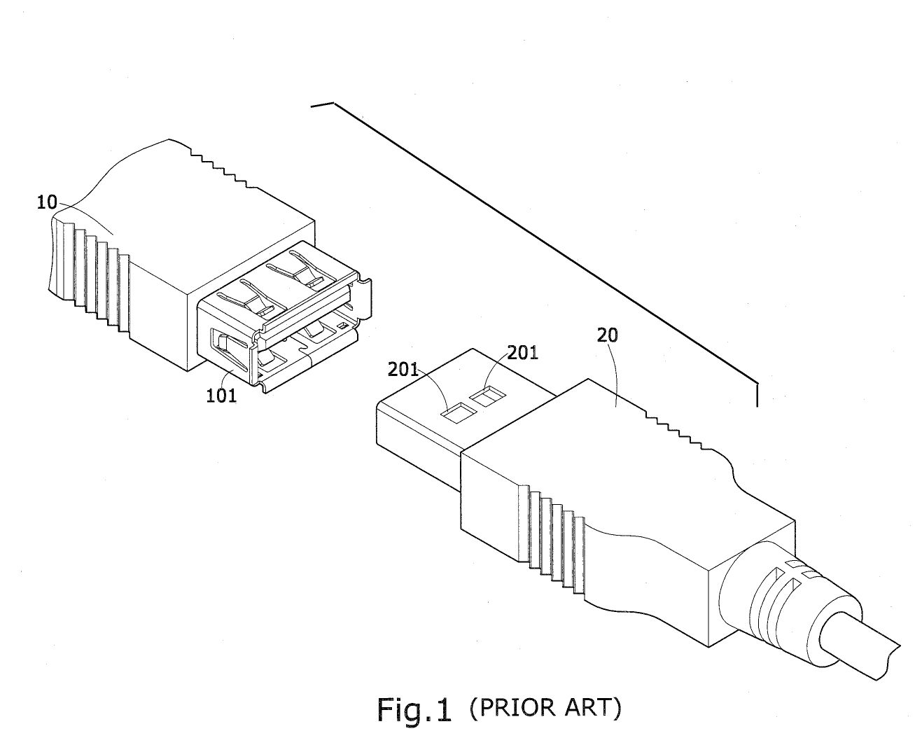

FIG. 2 is a three-dimensional exploded view of a preferred embodiment of the present invention;

FIG. 3 is a schematic view illustrating the operation of locking according to a preferred embodiment of the present invention;

FIG. 4 is a schematic view illustrating the operation of releasing according to a preferred embodiment of the present invention;

FIG. 5 is a three-dimensional exploded view of another preferred embodiment of the present invention; and

FIG. 6 is a cross-sectional view after the assembly of another preferred embodiment of the present invention.

### DETAILED DESCRIPTION OF THE INVENTION

In order to make the content of the present invention comprehensible, embodiments accompanied with figures are described in detail below.

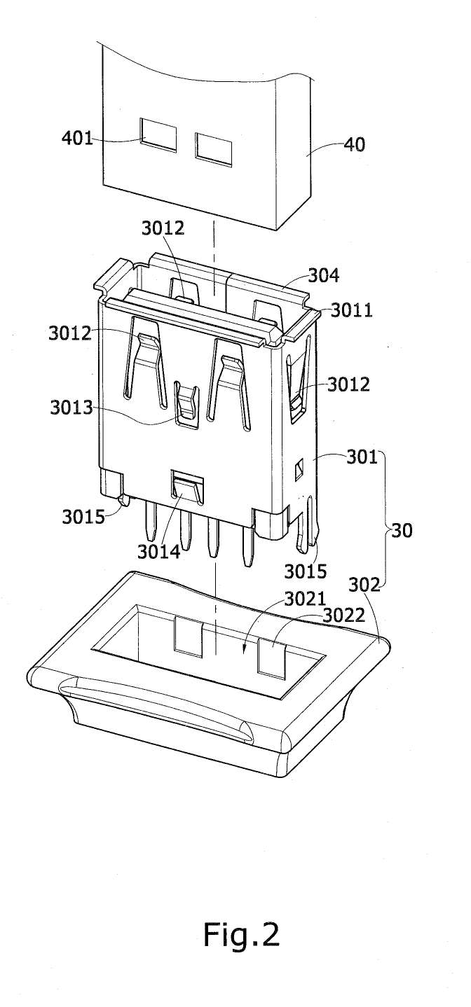

Referring to FIG. 2, a USB locking structure 30 of the present invention mainly includes a USB socket 301 and a collar 302.

The USB socket 301 has folded plates 3011 respectively disposed outward and perpendicularly on four edges of an open end thereof, and has a plurality of locking pieces 3012 disposed on each wall. The locking piece 3012 is elastic and V-shaped at a distal end thereof. Furthermore, the USB socket 301 has an urging piece 3013 in an inverted V-shape and a stopper piece 3014 with an up-warping distal end on a corresponding wall. The urging piece and the folded plate have a distance corresponding to the thickness of the collar 302 there-between, and the urging piece 3013 and the stopper piece 3014 have a distance corresponding to the thickness of the collar 302 there-between. In this embodiment, the USB socket 301 of the present invention is horizontally disposed with a pair of connecting portions 3015 at a distal end thereof.

The collar 302 has a rectangular through hole 3021 disposed in the middle. The through hole 3021 is of the same shape as the USB socket 301 and slightly larger in size. The collar 302 is fitted on the USB socket 301, and capable of moving by sliding. Further, the collar 302 has recesses 3022 respectively disposed at positions corresponding to the locking pieces 3012 on the walls of the through hole 3021. These recesses 3022 are used for precisely positioning the locking pieces 3012.

In the usage of the present invention, a USB plug 40 of an expanded equipment is inserted into the USB socket 301, such that the V-shaped bent portions at the distal ends of the locking pieces 3012 are engaged in locking slots 401 of the USB plug 40 so as to perform information linking or electrical connection between the expanded equipment and a computer. Besides, the collar 302 when reciprocally sliding is positioned by the folded plates 3011, the urging piece 3013, and the stopper piece 3014, so as to make the operation more convenient.

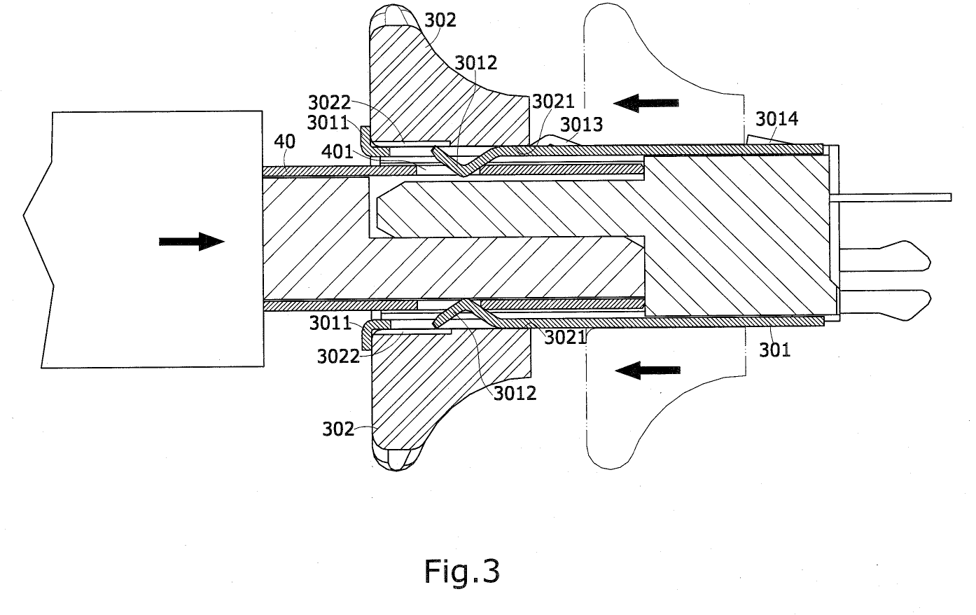

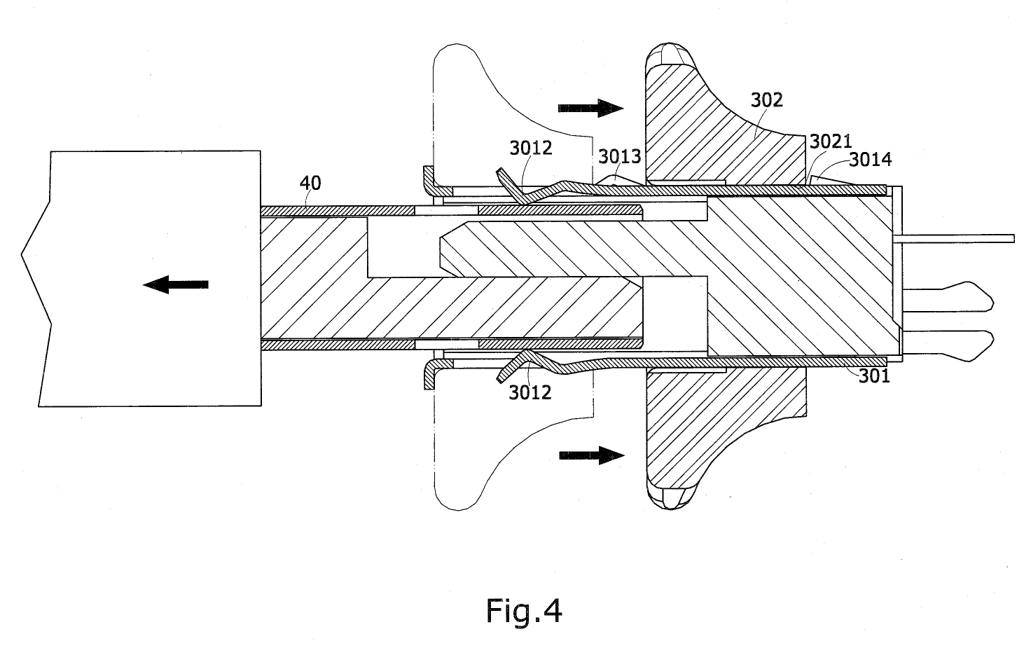

Referring to FIG. 3, during the locking of the present invention, the collar 302 slides toward the open end of the USB socket 301, so that the collar 302 is positioned between the folded plates 3011 and the urging piece 3013. The through hole of the collar may overlap the locking pieces 3012, and thus the locking pieces 3012 are pressed inward into the locking slots 401 of the USB plug 40. The recesses 3022 on the through hole 3021 of the collar 302, penetrated by the locking pieces 3012, are used for positioning the locking pieces 3012 and preventing scraping of the distal end of the USB socket 301 on the inner wall of the collar 302, so as to increase the smoothness of the sliding of the collar 302. Moreover, the folded plates 3011 are used to stop the collar 302 from continuously sliding forward and prevent the collar 302 from dropping off the USB socket 301 due to excessive sliding. The urging piece 3013 for positioning the collar 302 is used to locate the collar 302 between the folded plates 3011 and the urging piece 3013 without reverse sliding, and thus the collar 302 is completely locked. As the locking pieces 3012 pressed by the collar 302 are unable to flip upward, the distal ends of the locking pieces 3012 are engaged in the locking slots 401 of the USB plug 40. Thereby, the USB plug 40 may not drop even if pulled by an external force after being inserted into the USB socket 301. Referring to FIG. 4, to let go the USB plug 40, the collar 302 slides reversely, such that the through hole 3021 of the collar 302 passes through the locking pieces 3012 to make the locking pieces 3012 recover the elasticity, and the collar 302 arrives between the urging piece 3013 and the stopper piece 3014. Meanwhile, the stopper piece 3014 prevents the collar 302 from dropping off reversely. A user may detach the USB plug 40 from the USB socket 301 by merely applying a force.

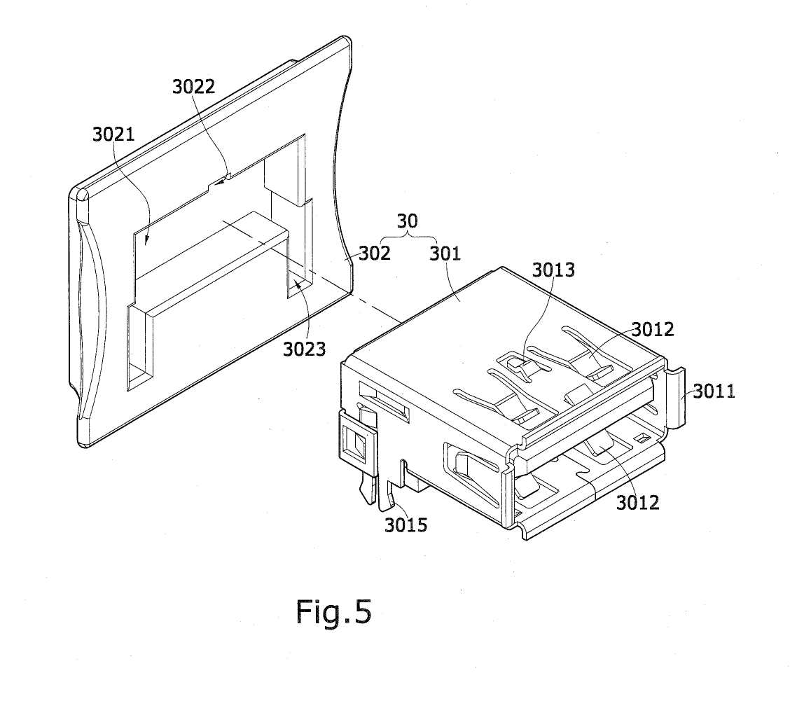

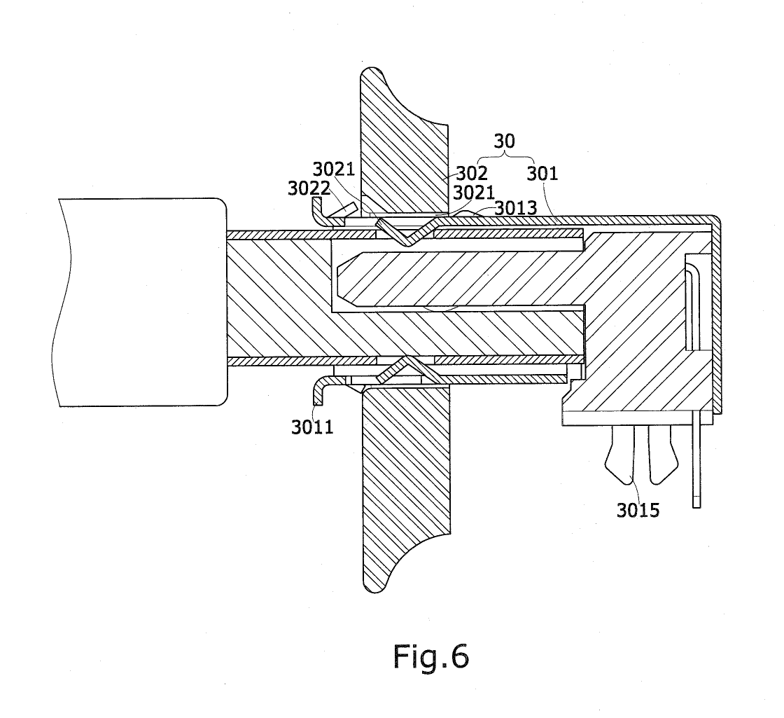

Referring to FIGS. 2, 5, and 6, another embodiment of the present invention is shown. The structures of the USB socket 301 and the collar 302 are identical to those in the above embodiment, but the USB socket 301 has a pair of connecting portions 3015 perpendicularly disposed at the distal end thereof. As such, two perforations 3023 are respectively disposed on two sides of the rectangular through hole 3021 of the collar 302, and pass through the perpendicularly disposed connecting portions 3015 to increase the convenience in assembly and usage.

In view of the above, the present invention achieves the following advantages in use.

1. Referring to FIGS. 3 and 4, in the present invention, an inner wall of the through hole 3021 of the collar 302 presses against the elastic locking pieces 3012 of the USB socket 301, such that the locking pieces 3012 are unable to flip and are firmly engaged with the locking slots 401 of the USB plug 40. Thereby, the purpose of locking is fulfilled, and the operation is quite convenient.

2. Besides, the USB socket 301 of the present invention is disposed with the folded plates 3011, the urging piece 3013, and the stopper piece 3014 for positioning the collar 302 when sliding, so as to further facilitate the operation.

3. The through hole 3021 of the collar 302 in the present invention is disposed with a plurality of recesses 3022 on the walls for precisely positioning the locking pieces.

However, the above embodiments are only used for illustration, instead of limiting the implementing scope of the present invention. Variations such as the selection of the material of the collar all fall within the scope of the present invention. Therefore, it is apparent to those skilled in the art that any modifications, equivalent substitutions, and variations made within the spirit and scope of the present invention fall within the scope of the present invention.

In view of the above, the USB locking structure of the present invention is inventive and applicable in the industry. Thereby, the applicant files an application for a utility model patent to the intellectual property office according to the provisions of the Patent Law.

What is claimed is:

1. A USB locking structure, comprising:
a USB socket, having a folded plate on a corresponding end edge of an open end, and at least one elastic locking piece on a corresponding wall thereof, respectively; and
a collar, disposed with a through hole in the middle thereof, wherein the through hole is of the same shape as the USB socket and slightly larger in size, the collar is fitted on the USB socket and capable of moving by sliding, and a wall of the through hole of the collar presses against the locking piece of the USB socket.

2. The USB locking structure according to claim 1, wherein the USB socket has an urging piece on the same side as the locking piece, and the locking piece is located between the urging piece and the folded plate.

3. The USB locking structure according to claim 2, wherein the USB socket has a stopper piece on the same side as the urging piece, and the urging piece is located between the locking piece and the stopper piece.

4. The USB locking structure according to claim 1, wherein the locking piece of the USB socket is V-shaped at a distal end thereof.

5. The USB locking structure according to claim 1, wherein the USB socket is horizontally disposed with a pair of connecting portions on one end.

6. The USB locking structure according to claim 1, wherein the USB socket is perpendicularly disposed with a pair of connecting portions on one end, and the through hole of the collar is disposed with a perforation on two sides respectively.

7. The USB locking structure according to claim 1, wherein the through hole of the collar is disposed with a plurality of recesses on the walls thereof, and each recess is corresponding to one locking piece of the USB socket.
